(19) United States
(12) Patent Application Publication
(10) Pub. No.: US 2015/0007212 A1
(43) Pub. Date: Jan. 1, 2015

(54) METHODS AND SYSTEMS FOR GENERATING MUSICAL INSIGNIAS FOR MEDIA PROVIDERS

(71) Applicant: United Video Properties, Inc., Santa Clara, CA (US)

(72) Inventor: Thomas S. Woods, Arlington Heights, IL (US)

(21) Appl. No.: 13/927,798

(22) Filed: Jun. 26, 2013

(51) Int. Cl. H04N 21/431; H04N 21/442; H04N 21/482; H04N 21/439; H04N 21/4722

(52) U.S. Cl. CPC H04N 21/4312; H04N 21/4394; H04N 21/4722; H04N 21/4821; H04N 21/44222
USPC 725/18; 725/40

(57) ABSTRACT

Methods and systems are discussed herein for generating audio presentations of musical insignias associated with media providers in an interactive media guide. For example, instead of requiring a user to read or otherwise visually identify a media object on an interactive guide, the media guidance application generates an audio presentation of a musical insignia known to a user to be associated with the media object.

### BACKGROUND

Electronic television program guides such as passive, interactive, and hybrid passive-interactive electronic television program guides are widely available. To take full advantage of such electronic television program guides, users must be able to read and understand the information and prompts presented in the displays. This may be difficult or impossible for those who are visually impaired or who cannot understand the language in which information is displayed.

### SUMMARY

Accordingly, methods and systems are discussed herein for generating audio presentations of musical insignias associated with media providers in an interactive media guide. The use of audio presentations of musical insignias provides increased support for users who may have difficulty with or cannot obtain guidance from typical visually-oriented guides (e.g., due to physical disabilities or illiteracy).

For example, instead of requiring a user to read or otherwise visually identify a media object on an interactive guide such as a media provider, a category of media listings, an icon corresponding to a guide function, or a media listing in an interactive guide, a media guidance application generates an audio presentation of a musical insignia associated with the media object. Based on the audio presentation of the musical insignia, the user can identify selected media objects without having to see or read the information in the interactive guide.

In some embodiments, the media guidance application may generate an interactive media guide that includes a media listing associated with a media provider, receive a user input navigating to the media listing, and in response to the user navigating to the media listing, determine a first musical insignia that is unique to the media provider, and generate an audio presentation of the first musical insignia. For example, as the user scans through a plurality of media listings, guide functions, etc., the media guidance application may generate musical insignias corresponding to the currently selected media object.

In some embodiments, the media guidance application determines the first musical insignia associated with the media provider by monitoring content of media associated with the media provider during a time period, detecting occurrences of a musical sequence in the content of the media, comparing a number of the occurrences to a threshold number, and then determine the musical sequence is the first musical insignia in response to the number of the occurrences exceeding the threshold number. For example, the media guidance application may monitor the audio output of a program on a particular television station. Upon detecting that a short tune or set of chords is repeated a particular number of times (e.g., the number of times necessary for a user to associate the tune or set of chords with the media provider), the media guidance determines that the short tune or set of chords is the musical insignia associated with the media provider. In some cases, the time period may correspond to a contiguous length of time (e.g., a two hour window) or may correspond to non-contiguous lengths of time (e.g., times when a user is accessing content from the media provider). In some cases, the media guidance application may also provide options for a user to customize the musical insignia.

In some embodiments, the media guidance application may determine the musical insignia of the media provider based on a representative media asset of the media provider. For example, in some cases, a media provider may have a “flagship” program that includes a popular jingle or intro music.

Additionally or alternatively, the media guidance application may cross-reference a media object in a local or remote database associated with musical insignias of media objects to determine the musical insignia to associate with the media object, and/or interpret media data transmitted with the interactive guide. Furthermore, in some embodiments, the media guidance application may determine content of a media asset associated with the media listing and modify the first musical insignia based on the content of the media asset. For example, the media guidance application may generate a first musical insignia associated with a media provider when a first type of content or a first media asset is currently being presented by the media provider and generate a second musical insignia associated with a media provider when a second type of content or a second media asset is currently being presented by the media provider. Additionally or alternatively, the media guidance application may receive user inputs customizing or modifying a musical insignia associated with a media object. For example, if the media guidance application cannot determine a musical insignia for a media object (or a user does not care for the determined musical insignia), the media guidance application may prompt a user for musical insignia selection.

In some embodiments, the media guidance application may also provide filtering options to user. For example, in response to a user input, the media guidance application may filter the media objects displayed based on whether or not the media objects are associated with musical insignias. By filtering the media objects based on whether or not the media objects are associated with musical insignias, the media guidance application can increase the ease of use for a user that relies on the musical insignias to navigate an interactive guide.

It should be noted, the systems and/or methods described above may be applied to, or used in accordance with, other systems and/or methods as described below.

### BRIEF DESCRIPTION OF DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a media guidance application that may generate musical insignias for media providers in an interactive media guide in accordance with some embodiments of the disclosure;

FIG. 2 shows another illustrative example of a media guidance application that may generate musical insignias for media providers in an interactive media guide in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 is a flowchart of illustrative steps for generating musical insignias for media providers in an interactive media guide in accordance with some embodiments of the disclosure;

FIG. 6 is a flowchart of illustrative steps for determining musical insignias in accordance with some embodiments of the disclosure; and

FIG. 7 is a flowchart of illustrative steps for selecting how to determine the musical insignias in accordance with some embodiments of the disclosure.

### DETAILED DESCRIPTION OF THE DRAWINGS

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content.

The media guidance application may also generate audio presentations of musical insignias associated with media providers in an interactive media guide. As referred to herein, “musical insignias” may encompass any combination of sound and silence that is uniquely associated with a media object in the mind of a listener. For example, a musical insignia may incorporate various elements, including, but not limited to, pitch (including melody and harmony), rhythm (as well as tempo, meter, and articulation), dynamics, and the sonic qualities of timbre and texture. For example, in some embodiments, the musical insignia may correspond to a song, theme/intro music, audio trademark, jingle, set of chords, rift, sound bite, audio track, verbal expression, station identification, slogan, sound effect or any other audio presentation that can be understood by a user to correspond to a media object. For example, the “NBC Chimes,” which consists of a succession of three distinct pitches: G3, E4, and C4 (middle C), sounded in that order, to create an arpeggiated C-major chord in the second inversion, within about two seconds time, and reverberated for another two or three seconds, may be the musical insignia for the National Broadcasting Company (“NBC”).

In some embodiments, the musical insignia may be based on a musical sequence. As used herein, a “musical sequence” refers to a combination of sound and silence with a distinct beginning and a distinct ending. As opposed to a musical insignia, a musical sequence may not be uniquely associated with a media object in the mind of a listener.

As used herein, a “media object” refers to human-readable and/or human-recognizable data appearing on the display screen associated with a user device. A media object may be a variable, function, or file. In some embodiments, the media object may appear as a character, icon, and/or input associated with a media asset, media listing, media provider, guide function, advertisement, and/or anything else featured in an interactive guide. Additionally, the media object may include the media asset, media listing, media provider, guide function, or advertisement, itself.

In some embodiments, the media object may correspond to a category or other grouping based on media criteria. As used herein, a “media criterion” or “media criteria” refers to a standard, rule, or test on which a judgment or decision about media assets, media listings, guide functions, media providers, and/or any other property or feature of an interactive media guide can be based. For example, in some embodiments, media criterion or media criteria may determine the media assets and/or listings, guide functions, etc. corresponding to a particular category identified by a musical insignia.

For example, a media criterion may relate to any characteristics associated with receiving, viewing, accessing, or navigating media objects, including, but not limited to, broadcast times, broadcast channels, titles, content descriptions, related episodes, series information, ratings information (e.g., parental control ratings, critic's ratings, etc.), genre or category information, cast and crew information, media format (e.g., standard definition, high definition, 3D, etc.), advertisement information (e.g., advertisers or sponsors of a media asset), on-demand information, social media recommendations, user recommendations, price, website referrals, content, delivery type (e.g., broadcast, recorded, streaming, pay-per-view, on-demand), media provider, type of media provider (e.g., Internet, cable, etc.), function type, operation type, and any other information that may describe a media asset, media listing, guide function, media provider, and/or any other property or feature of an interactive media guide.

As referred to herein, the term “media providers” refers to any entity associated with the production, transmission, authorship, or availability to end users of a media asset. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

As described herein, some media providers may be associated with a representative media asset. As used herein, a “representative media asset” refers to a media asset that is commonly associated with a particular media provider. For example, a representative media asset may include a flagship media asset, or the most important or well-known media asset within a group (e.g., media assets produced by the same media provider). For example, a representative media asset may include a popular television show (“Sportscenter”) that is accessed by a user from a single media provider (“ESPN”). To generate a musical insignia for the media provider, the media guidance application may monitor the television show for musical sequences (e.g., a portion of the theme/intro music of the television show) and select one of the musical sequences as the musical insignia for the media provider.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens.

In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections. In addition, media guidance data may also include an indication of a musical insignia that is associated with a media object.

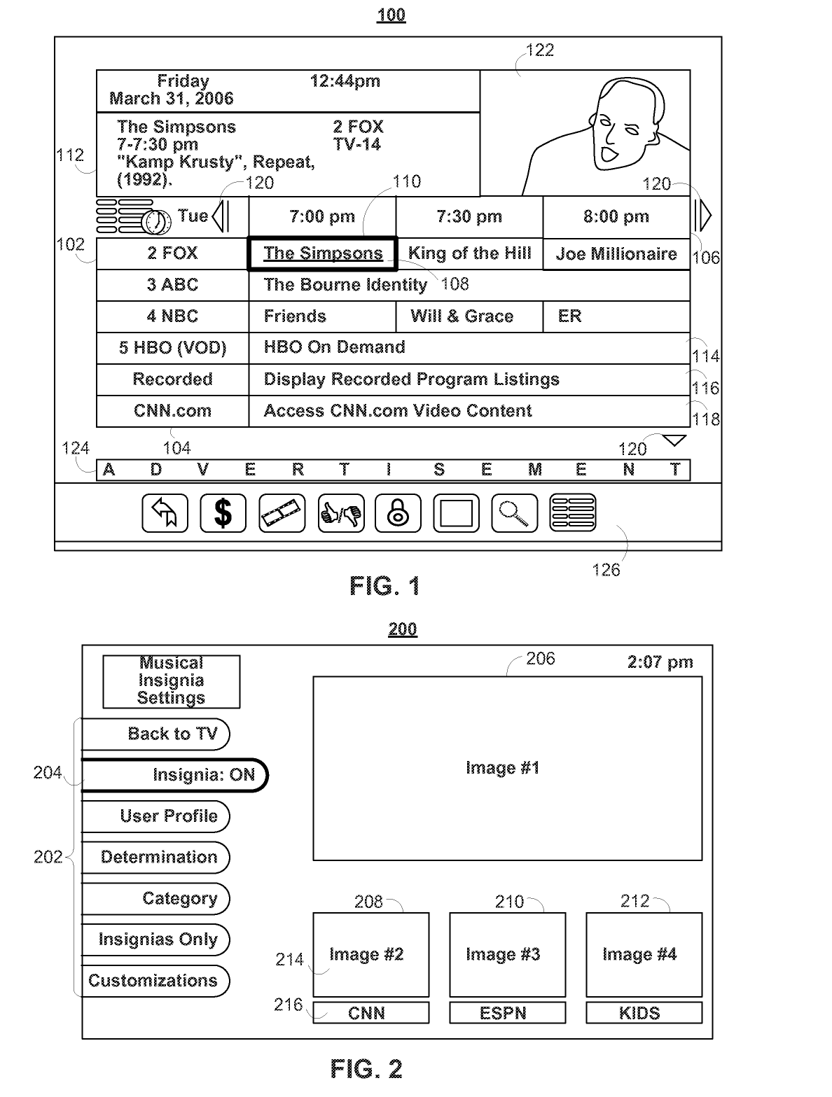

FIGS. 1-2 show illustrative display screens that may be used to provide media guidance data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by media provider (or source), by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information. In some embodiments, the media guidance data may be filtered by the media guidance application according to whether or not the media guidance data is associated with a musical insignia.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. As the user moves highlight region 110, the media guidance application may generate an audio presentation of a musical insignia of a media object within highlight region 110.

Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. Upon selecting the media guidance data associated with any of these listings, the media guidance application may also determine a musical insignia for each and generate an audio presentation of the determined musical insignia.

A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Upon selecting the media guidance data associated with any of these regions, the media guidance application may also determine a musical insignia for each and generate an audio presentation of the determined musical insignia. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, I I I et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Upon selecting the media guidance data associated with any of these options, the media guidance application may also determine a musical insignia for each and generate an audio presentation of the determined musical insignia. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

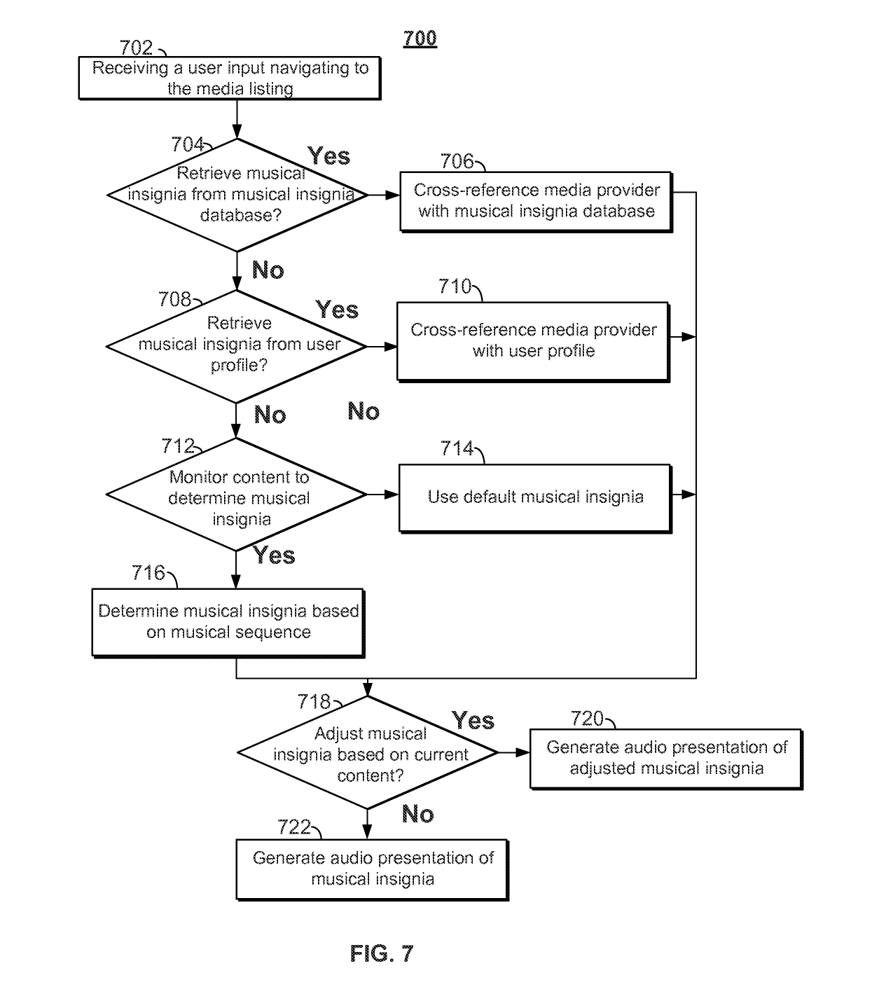

The media guidance application, including any musical insignias associated with media objects, may be personalized based on a user's preferences. A personalized media guidance application allows a user to customize displays, musical insignias and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the media guidance application. Customization of the media guidance application may be made in accordance with a user profile. The customizations may include selecting how musical insignias should be determined (e.g., as discussed below in relation to FIG. 7), manually adjusting determined musical insignias, applying settings that automatically modify musical insignias, varying presentation schemes (e.g., color scheme of displays, font size of text, volume of audio presentations, pitch of audio presentation, etc.), aspects of content listings displayed (e.g., only media objects with accompanying musical insignias, only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application (e.g., in order to determine musical insignias to associate with a media object). Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes a set-up screen associated with generating audio presentations of musical insignias. Selectable options 202 provide options for modifying musical insignias associated with various media objects For example, selection of “user profile” settings may allow a user to edit any musical insignias associated with any media object, any other information stored in his/her user profile, or switch between various user profiles. Selection of a “determination” method setting may allow a user to select the type of method for determining a particular musical insignia (e.g., as discussed below in relation to FIG. 7). Selection of “category” setting may allow a user to customize categories and/or musical insignias associated with categories. Selection of an “insignias only” setting may allow a user filter all available media listings, guide functions, available categories, etc. based on whether or not a musical insignia is presented, and selection of a “customization” setting may allow a user to customize any features provided by media guidance application and/or any musical insignia for any media object.

In display 200, selectable option 204 is selected, thus initiating audio presentations of musical insignias. In addition, the media guidance application provides listings 206, 208, 210, and 212 as broadcast program listings. In display 200 the listings may provide graphical images including cover art, still images from the content, video clip previews, live video from the content, or other types of content (e.g., audio notifications of musical insignias) that indicate to a user the content being described by the media guidance data in the listing.

Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

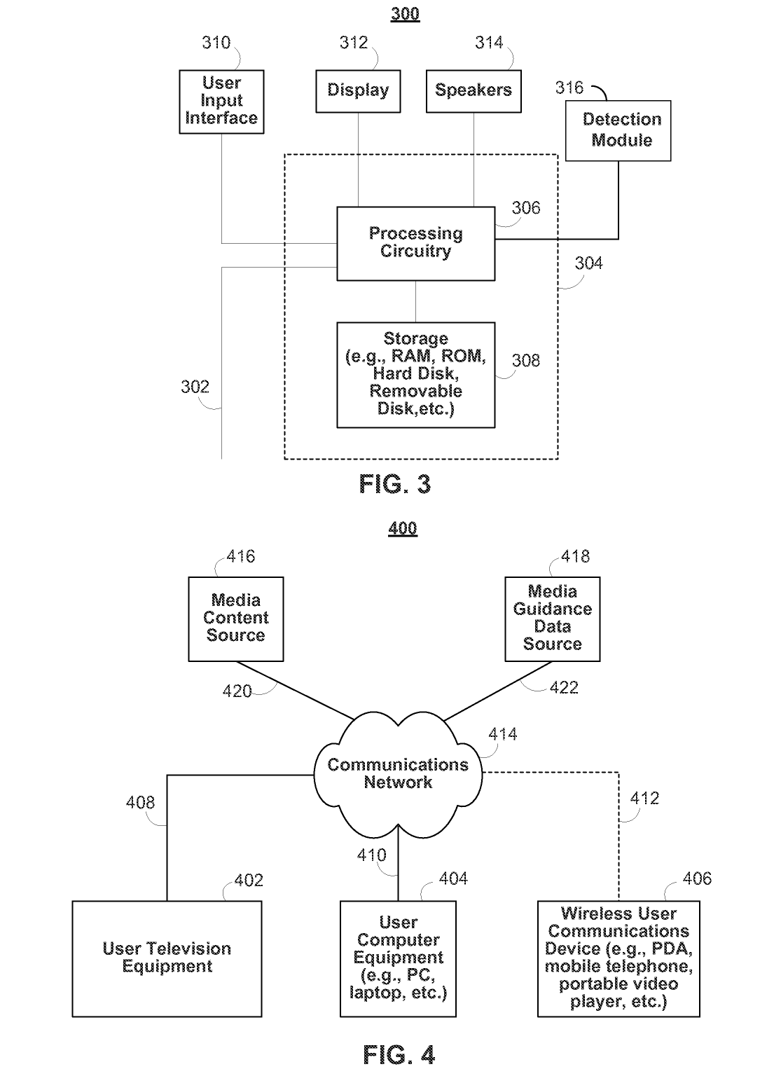

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above and/or, musical insignias associated with media objects as well as attributes of musical insignias. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

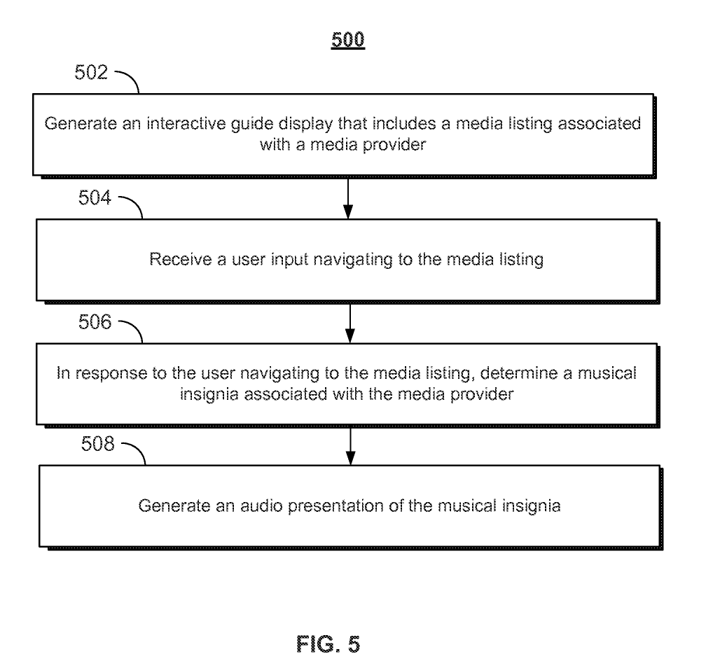

FIG. 5 is a flowchart of illustrative steps for generating musical insignias for media providers in an interactive media guide. Process 500 may be used to generate the display screens and musical insignias shown and described in FIGS. 1-2. It should be noted that process 500 or any step thereof could be provided by any of the devices shown in FIGS. 3-4. For example, process 500 may be executed by control circuitry 304 (FIG. 3) as instructed by a media guidance application implemented on user equipment device 402, 404, and/or 406 (FIG. 4) to musical insignias as a user navigates an interactive program guide (e.g., display 100 (FIG. 1)) displayed on a display device (e.g., display 312 (FIG. 3)) accessible by the media guidance application.

At step 502, the media guidance application generates an interactive guide display that includes a media listing associated with a media provider. For example, the media guidance application may generate a listing (e.g., program listing 108 (FIG. 1)) of a currently available media asset. In some embodiments, the media listing may meet particular media criteria. For example, the media listing may appear as part of a search or category function provided by the media guidance application.

In some embodiments, the media listing may appear after one or more filtering operations are applied to all available media listings. For example, the media guidance application may filter the available media listings according to whether or not the media listing is associated with a media asset of a particular genre. Additionally or alternatively, the media guidance application may filter the available media listings according to whether or not the media listing is associated with a musical insignia and/or whether the media guidance application will present an audio presentation of a musical insignia in response to a user selection. For example, in some embodiments, a user may wish to view only media listings that are associated with a musical insignia. In such cases, the user may select access the filtering feature via on-screen options (e.g., selectable options 202 (FIG. 2)).

At step 504, the media guidance application receives a user input navigating to the media listing. For example, using user input interface 310 (FIG. 3)), a user may navigate about an interactive guide (e.g., as shown and described in relation to FIGS. 1-2). In some embodiments, the media guidance application may respond to vocal and/or gesture-based commands. In some embodiments, as commands are received by the media guidance application, the media guidance application may generate (e.g., via control circuitry 304 (FIG. 3)) to audio response (e.g., audio feedback) such that a user received confirmation that an input was received.

At step 506, the media guidance application determines a first musical insignia associated with the media provider. In some embodiments, the musical insignia is unique to the media provider. For example, the musical insignia may not be associated with any other media provider. In some embodiments, the musical insignia may not be associated with any other media object. If the media guidance application determines that two media objects (e.g., two media providers) are associated with the same musical insignia, the media guidance application may resolve the conflict by assigning the musical insignia to one of the media objects and generating a custom musical insignia of the other. For example, the media guidance application may determine to assign one of the media objects the musical insignia based on that media object having superior characteristics (e.g., higher ratings, more previous user interactions, user preferences, etc.) than the other media object. Additionally or alternatively, the media guidance application may slightly modify the musical insignia for one or more media objects. For example, the musical insignia may be played at a higher (or lower) pitch, faster (or slower) beat, etc. for each media object (relative to a musical insignia for another media object) so that the musical insignia for each media object is unique.

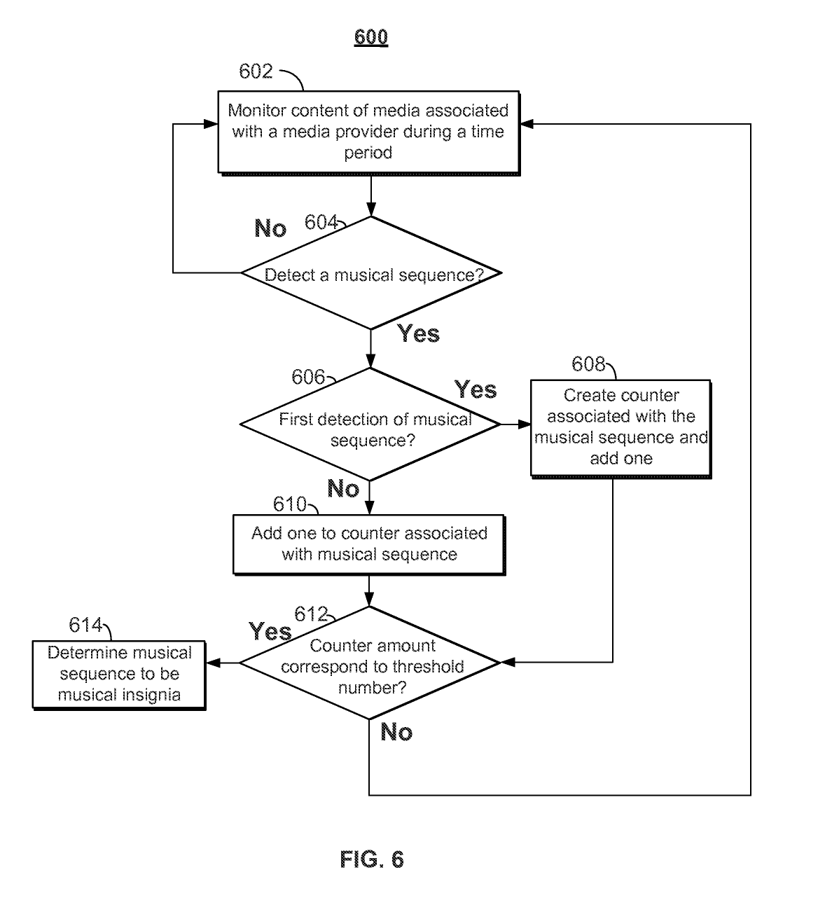

The media guidance application may determine a musical insignia to associate with the media provider and/or any other media object through a variety of means. In some embodiments, the media guidance application may determine a musical insignia to associate with a media provider and/or media object based on media guidance data (e.g., received from media guidance data source 418 (FIG. 4)). In some embodiments, information relating to a musical insignia may be received with content (e.g., as metadata) from media content source 416 (FIG. 4)). In some embodiments, the musical insignia may determine the musical insignia based on monitoring media associated with media objects (e.g., as discussed below in relation to FIG. 6)).

In some embodiments, the media guidance application may determine a musical insignia to associate with a media provider and/or object based on cross-referencing a database associated with musical insignias. For example, as discussed below in relation to FIG. 7, the media guidance application may query a database located either local (e.g., in storage 308 (FIG. 3)) or remote (e.g., media content source 416 (FIG. 4)), media guidance data source 418 (FIG. 4)), and/or any location accessible via communications network 414 (FIG. 4)) to user device (e.g., user device 300 (FIG. 3)) upon which the media guidance application is implemented.

In some embodiments, the database may be structured as a look-up table. For example, the media guidance application may query (e.g., using control circuitry 304 (FIG. 3)) the database for a musical insignia associated with a particular media object (e.g., a media provider). For example the media guidance application may input a unique identifier (e.g., the name of the media provider, a serial number associated with a particular media objects, etc.) into the database. In response, the media guidance application may receive (e.g., via I/O path 302 (FIG. 3)) the output of the database may output a musical insignia associated with the unique identifier.

Additionally or alternatively, the media guidance application may input media criteria into the database (e.g., describing the media object) and then filter the available musical insignias based on the media objects that correspond to the media criteria. For example, in order to determine a musical insignia for a media listing, the media guidance application may input the title, media provider, etc. or a media listing and filter out any musical insignia not associated with a media listings corresponding to the same title and media provider. In some embodiments, the media guidance application may perform multiple iterations of filtering in order to obtain only a single media object associated with a single musical insignia.

For example, if a media object is a media listing for a media asset or a media asset, the media guidance application may generate a musical insignia based on a song or theme music found in the media asset. In such cases, the media guidance application may input the title, media provider, etc. of the media listing or media asset into the database and receive information about the soundtrack of the media asset. In some embodiments, the media guidance application may extract a musical insignia from the soundtrack and/or search for a musical insignia corresponding to the soundtrack (e.g., a musical insignia of the some genre as the of the music of the soundtrack).

In some embodiments, the media guidance application may also input a function associated with a media object. For example, the media guidance application may determine a musical insignia based on a function associated with a media object. For example, a “pause” icon may be associated with screeching tires frequently associated with a car slamming on the breaks. Likewise, the media guidance application may associate a “fast-forward” icon with an automobile accelerating. Similar to inputting media criteria, by inputting the function of the media object into the database, the media guidance application may receive a musical insignia associated with function.

In addition, the media guidance application may use multiple types of optical character recognition and/or fuzzy logic, for example, when analyzing media guidance data or comparing multiple data fields (e.g., as contained in the described databases). For example, the media guidance application may arrange the text into data fields and cross-reference the data fields with other data fields. Using fuzzy logic, the system may determine two fields and/or values to be identical even though the substance of the data field or value (e.g., two different spellings) is not identical. In some embodiments, the system may analyze particular data fields of a database for particular values or text. Furthermore, the data fields may contain values (e.g., the data fields could be expressed in binary or any other suitable code or programming language) other than human-readable text.

At step 508, the media guidance application may generate an audio presentation of the musical insignia. For example, the media guidance application may transmit a command (e.g., via control circuitry 304 (FIG. 3)) to generate an audio presentation (e.g., via speakers 314 (FIG. 3)) of the musical insignia with the user device (e.g., user device 300 (FIG. 3)) upon which the media guidance application is implemented.

In some embodiments, the media guidance application may also generate audio presentations of musical insignias on other devices. For example, while a user is navigating through an interactive guide on a first device (e.g., a television), the media guidance application may instruct (e.g., via control circuitry 304 (FIG. 3)) a second device (e.g., a mobile phone, a hearing aid, etc.) to generate the audio presentation of the musical insignia. For example, if a user is currently seating at a distance from a display device (e.g., a television) that makes reading information on an interactive media guide difficult, the media guidance application may (e.g., either in response to a user request or automatically upon determining the distance of the user from the display device) instruct another device (e.g., associated with a user profile of a user) to generate the audio presentations.

It is contemplated that the steps or descriptions of FIG. 5 may be used with any other embodiment of this disclosure. In addition, the steps and descriptions described in relation to FIG. 5 may be done in alternative orders or in parallel to further the purposes of this disclosure. For example, each of these steps may be performed in any order or in parallel or substantially simultaneously to reduce lag or increase the speed of the system or method.

FIG. 6 is a flowchart of illustrative steps for determining musical insignias. Process 600 may be used to generate the display screens and musical insignias shown and described in FIGS. 1-2. It should be noted that process 600 or any step thereof could be provided by any of the devices shown in FIGS. 3-4. For example, process 600 may be executed by control circuitry 304 (FIG. 3) as instructed by a media guidance application implemented on user equipment device 402, 404, and/or 406 (FIG. 4) to musical insignias as a user navigates an interactive program guide (e.g., display 100 (FIG. 1)) displayed on a display device (e.g., display 312 (FIG. 3)) accessible by the media guidance application.

As discussed above, the media guidance application may determine the musical insignia to associate with a media object using several methods, or a combination thereof. For example, the media guidance application may determine a musical insignia based on media guidance data, based on user inputs or information in a user profile, and/or based on cross-referencing a database associated with musical insignias. Additionally or alternatively, the media guidance application may determine a musical insignia to associate with a media object based on monitoring content or functions associated with the media object.

Process 600 is another method for determining a musical insignia to associate with a media object. In FIG. 6, a media guidance application determines a musical insignia associated with a media provider based on the content of media assets that are frequently transmitted or otherwise available from the media provider. For example, if a media provider is associated with a particular genre (e.g., horror movies), the media guidance application may select a musical insignia typically associated with horror movies (e.g., screaming, spooky music, etc.). It should be noted that in some embodiments, process 600 may be used in combination with other methods of determining a musical insignia. Moreover, in some embodiments, process 600 may be combined with process 500 (FIG. 5) or process 700 (FIG. 7) and/or modified based on a user profile or a user input (e.g., selecting one of selectable options 202 (FIG. 2)).

At step 602, the media guidance application monitors content of media associated with a media provider during a period of time. For example, the media guidance application may determine the content of a media asset by analyzing the content of available media assets. In some embodiments, the media guidance application may incorporate or have access to one or more content-recognition modules, which may be used by the media guidance application to analyze media objects and/or the content of media objects. For example, the media guidance application may include an object recognition module. The object recognition module may use edge detection, pattern recognition, including, but not limited to, self-learning systems (e.g., neural networks), optical character recognition, on-line character recognition (including, but not limited to, dynamic character recognition, real-time character recognition, intelligent character recognition), and/or any other suitable technique or method to determine the objects in and/or characteristics of video and audio content. For example, the media guidance application may receive a media asset in the form of a video (e.g., an audio/video recording of a user). The video may include a series of frames. For each frame of the video, the media guidance application may use an object recognition module to determine the content and context of a media asset for use in determining a musical insignia to associate with a media object.

In some embodiments, the content-recognition module or algorithm may also include audio analysis and speech recognition techniques, including, but not limited to, Hidden Markov Models, dynamic time warping, and/or neural networks (as described above) to process audio data and/or translate spoken words into text or other data forms that may be processed by the media guidance application. The content-recognition module may also use any other suitable techniques for processing audio and/or visual data. For example, the content-recognition module may analyze audio data to determine the content and context of a media asset for use in determining a musical insignia to associate with a media object.

The amount of time that the media guidance application monitors content of media associated with a media provider may vary. For example, in some embodiments, the media guidance application may monitor the content of the media continuously. In some embodiments, the media guidance application may monitor the content of the media sporadically. For example, the media guidance application may monitor content of the media daily, weekly, etc. The media guidance application may monitor content at the same time of day or at random times. The times may also be linked to other factors such as user preferences, ratings, social media activity, etc. The amount of time that the content is monitored may also depend on other factors such as user preferences, times when the user is accessing media from the media content provider, etc.

At step 604, the media guidance application determines whether or not a musical sequence is detected. For example, the media guidance application may monitor the content of the media associated with the media provider for the occurrence of musical sequences. In some embodiments, musical sequences or portions of musical sequences in media provided by a media provider may be extracted by the media guidance application (e.g., via control circuitry 304 (FIG. 3)) and used as musical insignias for the media provider. For example, the media guidance application may monitor the content of the media in order to detect a particular theme song, trademark, or any other audio indication in the media that a user may associate with the media provider.

If a musical sequence is not detected, the media guidance application returns to step 602 and continues to monitor the content of the media associated with the media provider. If the media guidance application does detect a musical sequence, the media guidance application determines whether or not this is the first instance that this particular musical sequence was detected at step 606.

If this is the first instance of the particular musical sequence, the media guidance application creates a counter associated with the detected musical sequence and adds one unit to the counter at step 608. If this is not the first instance of the particular musical sequence, the media guidance application adds one unit to the counter associated with the particular musical sequence at step 610. For example, the media guidance application may (e.g., via control circuitry 304 (FIG. 3)) maintain a count of each musical sequence (e.g., in storage 308 (FIG. 3)) of user equipment 402, 404, and/or 406 (FIG. 4)). Each time a musical sequence is detected, the media guidance application (e.g., via control circuitry 304 (FIG. 3)) may compare the detected musical sequence to the stored musical sequences (e.g., in storage 308 (FIG. 3)).

At step 612, the media guidance application determines whether or not the counter amount for the musical sequence corresponds to a threshold number. For example, a threshold number may be a number of instances of a musical sequence after which a user will associate the musical sequence with the media provider. For example, if station identification tones are played enough times, a user will start to associate the tones with the media provider. In some embodiments, the instances of the musical sequence may all occur during a particular media asset (e.g., a series or episode of a program) or in different media assets (e.g., different programs). For example, the musical sequence may be associated with a theme song or intro music that is featured in a program that is regularly played by a particular media provider.

In some embodiments, the threshold number may be determined based on a user profile (e.g., according to a user preference). The media guidance application may also determine a threshold number based on passive information, such as observing user interactions, industry metrics, etc., or active information, such as requesting the user answer questionnaires, monitoring. The threshold number may be retrieved from a remote database (e.g., located at media content source 416, media guidance data source 418, and/or any device accessible via communications network 414 (FIG. 4)) or a local database (e.g., located at storage 308 (FIG. 3)).

If the number of musical sequences recorded by the counter corresponds to the threshold number (e.g., is equal to the threshold number), the media guidance application determines the musical sequence to be the musical insignia associated with the media provider at step 614. If the number of musical sequences recorded by the counter does not correspond to the threshold number (e.g., is less than the threshold number), the media guidance application returns to step 602.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order or in parallel or substantially simultaneously to reduce lag or increase the speed of the system or method.

FIG. 7 is a flowchart of illustrative steps for determining musical insignias. Process 700 may be used to generate the display screens and musical insignias shown and described in FIGS. 1-2. It should be noted that process 700 or any step thereof could be provided by any of the devices shown in FIGS. 3-4. For example, process 700 may be executed by control circuitry 304 (FIG. 3) as instructed by a media guidance application implemented on user equipment device 402, 404, and/or 406 (FIG. 4) to musical insignias as a user navigates an interactive program guide (e.g., display 100 (FIG. 1)) displayed on a display device (e.g., display 312 (FIG. 3)) accessible by the media guidance application.

In some embodiments, the media guidance application may determine (e.g., via control circuitry 304 (FIG. 3)) a musical insignia to associate with a media object prior to a user selecting the media object and storing (e.g., in storage 308 (FIG. 3)) for later retrieval. In some embodiments, for example, as described in FIG. 7, the media guidance application may determine the musical insignia associated with a media object in real-time when a user selects a media object.

At step 702, the media guidance application receives a user input navigating to a media listing. For example, the media guidance application may receive a user input (e.g., via user input interface 310 (FIG. 3)) selecting (e.g., with highlight region 110 (FIG. 1)) a media listing (e.g., program listing 108 (FIG. 1)).

At step 704, the media guidance application determines whether or not to retrieve a musical insignia from a musical insignia database. In some embodiments, the musical insignia database may be located remotely (e.g., at media content source 416, media guidance data source 418, and/or any location accessible via communications network 414 (FIG. 4)) or locally (e.g., on user equipment 402, 404, and/or 406 (FIG. 4)).

The musical insignia database may include musical insignia determined by third parties or content providers. For example, in some embodiments, the media guidance application may receive the musical insignia associated with a media object from a third party or content provider. If the media guidance application determines to retrieve the musical insignia from a musical insignia database, the media guidance application proceeds to step 706 and cross-references the media provider with a musical insignia database.

For example, the database may be structured as a look-up table in which the media guidance application may query (e.g., using control circuitry 304 (FIG. 3)) the database for a musical insignia associated with a particular media provider (e.g., a television station). In some embodiments, the media guidance application may input (e.g., via control circuitry 304 (FIG. 3)) a unique identifier (e.g., the name of the media provider, a serial number associated with particular media objects, etc.) into the database, and in response, the media guidance application may receive (e.g., via I/O path 302 (FIG. 3)) a musical insignia associated with the unique identifier.

If the media guidance application determines not to retrieve the musical insignia from a musical insignia database, the media guidance application proceeds to step 708. At step 708, the media guidance application determines whether or not to retrieve a musical insignia from a user profile. In some embodiments, the user profile may be located remotely (e.g., at media content source 416, media guidance data source 418, and/or any location accessible via communications network 414 (FIG. 4)) or locally (e.g., on user equipment 402, 404, and/or 406 (FIG. 4)).

The user profile may include musical insignia determined by the user. For example, in some embodiments, the media guidance application may receive the musical insignia based on prior user selections or user preferences retrieved from the user profile. If the media guidance application determines to retrieve the musical insignia from a user profile, the media guidance application proceeds to step 710 and cross-references the media provider with the user profile.

For example, the user profile may be structured as a look-up table in which the media guidance application may query (e.g., using control circuitry 304 (FIG. 3)) the user profile for a musical insignia associated with a particular media provider (e.g., a television station) or conditions or rules associated with selecting a musical insignia. In some embodiments, the media guidance application may input (e.g., via control circuitry 304 (FIG. 3)) a unique identifier or rules into the user profile, and in response, the media guidance application may receive (e.g., via I/O path 302 (FIG. 3)) a musical insignia associated with the unique identifier.

If the media guidance application determines not to retrieve the musical insignia from a musical insignia database, the media guidance application proceeds to step 712.

At step 712, the media guidance application determines whether to monitor content to determine musical insignia. For example, if a media provider is associated with a particular media asset (e.g., a highly rated program), the media guidance application may select a musical insignia typically associated with the program. If the media guidance application determines to monitor content associated with a media object to determine a musical insignia (e.g., as discussed above in relation to FIG. 6), the media guidance application determines a musical insignia based on a content associated with a media object (e.g., content of a media asset provided by a particular media provider) at step 716.

If the media guidance application determines not to monitor content associated with a media object to determine a musical insignia (e.g., as discussed above in relation to FIG. 6), the media guidance application uses a default musical insignia at step 714. For example, the media guidance application may select a musical insignia at random or may provide a verbal description of the media object (e.g., generating an audio presentation of any text displayed on the interactive guide).

Following step 714 or step 716, the media guidance application proceeds to step 718. At step 718, the media guidance application may adjust the musical insignia based on current content. For example, the media guidance application may adjust a determined musical insignia in order to make it correspond to current content. For example, if a media provider is currently providing an action movie, the musical insignia may be played at a higher volume. In another example, if a media provider is currently providing a particular media asset the media guidance application may generate an audio presentation of the determined musical insignia following by a musical insignia associated with the media asset.

If the media guidance application determines to adjust the musical insignia based on the current content, the media guidance application proceeds to step 720 and generates an audio presentation of the adjusted musical insignia. If the media guidance application determines not to adjust the musical insignia based on the current content, the media guidance application proceeds to step 722 and generates an audio presentation of determined musical insignia without any adjustment.

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order or in parallel or substantially simultaneously to reduce lag or increase the speed of the system or method.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real-time. It should also be noted, the systems and/or methods described above may be applied to, or used in accordance with, other systems and/or methods.

1. A method of generating musical insignias for media providers, the method comprising:
generating an interactive media guide that includes a media listing associated with a media provider;
receiving a user input navigating to the media listing;
in response to the user navigating to the media listing, determining a first musical insignia associated with the media provider, wherein the first musical insignia is unique to the media provider; and
generating an audio presentation of the first musical insignia.

2. The method of claim 1, further comprising:
generating a media object, wherein the media object includes a category of media listings, an icon associated with a guide function, or a media listing;
receiving a user input navigating to the media object;
in response to the user navigating to the media object, determining a second musical insignia associated with the media object, wherein the second musical insignia is unique to the media object; and
generating an audio presentation of the second musical insignia.

3. The method of claim 1, wherein determining the first musical insignia associated with the media provider further comprises:
monitoring content of media associated with the media provider during a time period;
detecting occurrences of a musical sequence in the content of the media;
comparing a number of the occurrences to a threshold number; and
in response to the number of the occurrences exceeding the threshold number, determining the musical sequence is the first musical insignia.

4. The method of claim 3, wherein the time period is associated with a period of time in which a user accesses the media provider.

5. The method of claim 1, further comprising:
determining a representative media asset of the media provider, wherein the representative media asset indicates a source indicator associated with the media provider;
monitoring content of the representative media asset; and
associating the first musical insignia with the media provider in response to detecting a threshold number of audio presentations corresponding to the first musical insignia in the content of the media asset.

6. The method of claim 1, further comprising determining the first musical insignia based on cross-referencing the media provider in a database associated with musical insignias of media providers.

7. The method of claim 1, further comprising determining the first musical insignia based on interpreting media data used to generate the interactive media guide.

8. The method of claim 1, further comprising determining content of a media asset associated with the media listing and modifying the first musical insignia based on the content of the media asset.

9. The method of claim 1, further comprising:
filtering the media providers based on whether the media providers are associated with musical insignias; and
generating for display media listings associated with the media providers that are associated with musical insignias.

10. The method of claim 1, further comprising receiving a user input modifying the first musical insignia.

11. A system of generating musical insignias for media providers, the system comprising control circuitry configured to:
generate an interactive media guide that includes a media listing associated with a media provider;
receive a user input navigating to the media listing;
in response to the user navigating to the media listing, determine a first musical insignia associated with the media provider, wherein the first musical insignia is unique to the media provider; and
generate an audio presentation of the first musical insignia.

12. The system, of claim 11, wherein the control circuitry is further configured to:
generate a media object, wherein the media object includes a category of media listings, an icon associated with a guide function, or a media listing;
receive a user input navigating to the media object;
in response to the user navigating to the media object, determine a second musical insignia associated with the media object, wherein the second musical insignia is unique to the media object; and
generate an audio presentation of the second musical insignia.

13. The system of claim 11, wherein determining the first musical insignia associated with the media provider further comprises:
monitoring content of media associated with the media provider during a time period;
detecting occurrences of a musical sequence in the content of the media;
comparing a number of the occurrences to a threshold number; and
in response to the number of the occurrences exceeding the threshold number, determining the musical sequence is the first musical insignia.

14. The system of claim 13, wherein the time period is associated with a period of time in which a user accesses the media provider.

15. The system of claim 11, wherein the control circuitry is further configured to:
determine a representative media asset of the media provider, wherein the representative media asset indicates a source indicator associated with the media provider;
monitor content of the representative media asset; and
associate the first musical insignia with the media provider in response to detecting a threshold number of audio presentations corresponding to the first musical insignia in the content of the media asset.

16. The system of claim 11, further comprising control circuitry configured to determine the first musical insignia based on cross-referencing the media provider in a database associated with musical insignias of media providers.

17. The system of claim 11, further comprising control circuitry configured to determine the first musical insignia based on interpreting media data used to generate the interactive media guide.

18. The system of claim 11, further comprising control circuitry configured to determine content of a media asset associated with the media listing and modifying the first musical insignia based on the content of the media asset.

19. The system of claim 11, further comprising control circuitry configured to:
filter the media providers based on whether the media providers are associated with musical insignias; and
generate for display media listings associated with the media providers that are associated with musical insignias.

20. The system of claim 11, further comprising control circuitry configured to receive a user input modifying the first musical insignia.

21-40. (canceled)
